(19) United States
(12) Patent Application Publication
(10) Pub. No.: US 2007/0074634 A1
(43) Pub. Date: Apr. 5, 2007

(54) Plate cylinder locking mechanism

(76) Inventor: Rex Jablonski, Randolph, NJ (US)

Correspondence Address: ECKERT SEAMANS CHERIN & MELLOTT, 600 GRANT STREET, 44TH FLOOR, PITTSBURGH, PA, 15219, US

(21) Appl. No.: 10/548,746

(22) PCT Filed: Oct. 15, 2003
(86) PCT No.: PCT/US03/32608

§ 371 Date: Dec. 8, 2006

Related U.S. Application Data
(60) Provisional application No. 60/420,673, filed on Oct. 22, 2002.

(51) Int. Cl. B41F 1/34

(52) U.S. Cl. 101/480

(57) ABSTRACT

A hydraulic clamp for being mounted on a shaft. The clamp may comprise a clamp body; an aperture in the clamp body for receiving the shaft, the aperture extending in an axial direction of the clamp body from a first end to a second end; a recess formed in the clamp body and substantially surrounding the aperture, for receiving a pressure medium; the clamp body having at the first end a pressure cylinder communicating with the recess for pressurizing the pressure medium and thereby deforming the recess sufficiently to secure the clamp to the shaft; the pressure cylinder having a corresponding piston arranged for axial movement toward the second end for pressurizing the pressure medium. The piston and cylinder may be threaded such that rotation of the piston drives the piston into the cylinder toward the second end to pressurize the pressure medium. The piston may comprise a flange, disposed on the piston for engaging the clamp body for limiting axial movement of the piston toward the second end. The clamp body may further comprise a stop, disposed for engaging the piston and for limiting axial movement of the piston away from the second end. The stop may have an aperture arranged axially of the piston, the aperture permitting a tool to access the piston by being inserted generally in the axial direction.

### BACKGROUND OF THE INVENTION

The invention relates to an improved hydraulic clamp for releasably connecting a cylindrical printing head to a printing shaft in a beverage container decorating machine.

### BACKGROUND ART

A known beverage container decorator machine is disclosed, for example, in U.S. Pat. No. 5,819,648.

As best seen in FIGS. 3 and 4 of the '648 patent, a decorator machine includes a plurality of decorator cylinder assemblies 30 each having a printing head 32. The printing head 32 is removably mounted on a shaft head 36 of a printing shaft 34 for being rotated to carry out a decorating operation on, for example, a soft-drink can. The decorator printing plates are typically made from plastic, with a steel backing for being magnetically adhered to the printing head.

A conventional hydraulic clamp suitable for retaining the printing head on the printing shaft of the decorator is disclosed in PCT international application WO98/46896. The disclosures of the foregoing publications are incorporated by reference.

Advantages of the use of this type of hydraulic clamp in the locking mechanism include easy removal and assembly of the plate cylinder for labeling changes. The clamp provides zero clearance after locking the hydraulic hub, which results in improved printing quality. Earlier devices required clearance in order to be assembled onto the shaft.

For pressurizing the hydraulic chamber to clamp the device in WO '896 onto a shaft, the device requires either a plurality of axial pressure screws mounted in a complicated collar arrangement, or a single pressure screw oriented circumferentially of the device. In the first case, the removal operation is slow and inconvenient. In the second case, the pressure screw will not be easily and safely accessible in the environment of the typical container decorator machine.

### SUMMARY OF THE INVENTION

Responding to these drawbacks of the prior art, the present invention, provides an improved hydraulic clamp, particularly for releasably retaining a printing head on a printing shaft in a beverage container decorating machine.

The improvements may include a hydraulic clamp with a single, large, axially arranged pressure cylinder; a correspondingly enlarged axially arranged screw for actuating the hydraulic cylinder; a flange on the screw for stopping the screw in one direction; and a stop plate for stopping the screw in the other direction. With these features, the hydraulic clamp can be easily released from the shaft by a single operation of the pressure screw, which can be carried out from a location safely spaced away from the end of the shaft in the axial direction. Thus, the invention provides a clamp with quicker release and greater safety than with the known clamps.

The advantages of the invention include the use of a single screw, which provides quicker release than the axial clamp of WO '896, which has multiple, smaller screws; the flange; and the stop plate.

The activating screw can be mathematically engineered to perform at least three functions:
A. To move a specific volume of hydraulic grease within the chamber of the hub.
B. To provide sufficient clamping force, by means of the grease, to take up the inner tolerances of the hub and provide effective clamping.
C. To provide reusability; as many mountings (times the hub is released and re-engaged) as possible, until the hub has to be recharged with grease.

According to an aspect of the invention, a hydraulic clamp for being mounted on a shaft may comprise a clamp body; an aperture in said clamp body for receiving said shaft, said aperture extending in an axial direction of said clamp body from a first end to a second end thereof; a recess formed in said clamp body and substantially surrounding said aperture, for receiving a pressure medium; said clamp body having at said first end thereof a pressure generator communicating with said recess for pressurizing said pressure medium and thereby deforming said recess sufficiently to secure said clamp to said shaft; wherein said pressure medium is pressurized by an axial movement of said pressure generator toward said second end; and wherein said hydraulic clamp comprises a first structure which limits said axial movement of said pressure generator toward said second end.

According to another aspect of the invention, the hydraulic clamp may comprise a clamp body; an aperture in said clamp body for receiving said shaft, said aperture extending in an axial direction of said clamp body from a first end to a second end thereof; a recess formed in said clamp body and substantially surrounding said aperture, for receiving a pressure medium; said clamp body having at said first end thereof a single pressure cylinder communicating with said recess for pressurizing said pressure medium and thereby deforming said recess sufficiently to secure said clamp to said shaft; said single pressure cylinder having a corresponding single piston arranged for axial movement toward said second end for pressurizing said pressure medium.

In other aspects, the invention is not limited to a single piston and cylinder.

The piston and cylinder may be threaded such that rotation of said piston drives said piston into said cylinder toward said second end to pressurize said pressure medium.

The piston may comprise a flange, which is disposed on said piston for engaging said clamp body and thereby limiting axial movement of said piston toward said second end.

The clamp body may comprise a stop, which is disposed for engaging said piston and thereby limiting axial movement of said piston away from said second end. The stop may have an aperture arranged axially of said piston, said aperture permitting a tool to access said piston by being inserted generally in said axial direction.

Other features and advantages of the present invention will become apparent from the following description of embodiments of the invention which refers to the accompanying drawings.

### BRIEF DESCRIPTION OF THE DRAWINGS

FIG. 1 is a side view of the disclosed embodiment of the invention, shown partly in cross-section, taken along line B-B of FIG. 2.

FIG. 2 is an end view of the disclosed embodiment.

### DETAILED DESCRIPTION

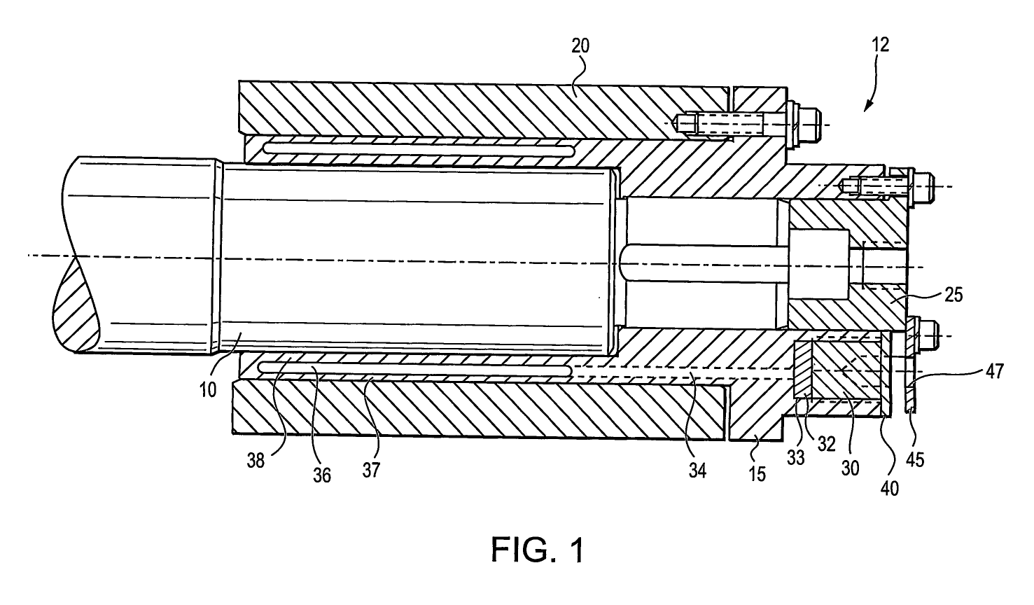

Referring now to FIG. 1, the conventional printing shaft is shown at 10. Mounted on the shaft is a hydraulic clamp 12. The hydraulic clamp 12 comprises a hydraulic hub 15. Printing cylinder 20 is mounted on the hydraulic hub 15 in known fashion. An outer hub 25 is provided on the hydraulic hub 15. The hydraulic hub 15 provides for fine positioning of the printing cylinder 20 for proper printing, again in known fashion.

The hydraulic hub 15 has a circumferential annular recess 36 defined by at least one expandable outer wall 37 and an expandable inner wall 38. When the recess 36 is pressurized, the inner wall 38 clamps onto the shaft 10 and the outer wall 37 clamps against the inside diameter of the printing cylinder at the same time. The hydraulic hub 15 further has a single, large-diameter pressure screw 30 which moves a piston 32 for compressing hydraulic fluid in a hydraulic chamber or recess 33. The hydraulic chamber or recess 33 communicates via a passage 34 with the circumferential chamber or recess 36.

In contrast to the device in WO '896, which requires either a plurality of axial screws mounted in a complicated collar arrangement, or a single screw mounted circumferentially, the present invention requires only a single, axially arranged screw 30 for pressurizing the hydraulic chamber or recess 36. Therefore, the hydraulic clamp 12 can be more easily released from the shaft 10 by a single unscrewing operation, which can be carried out with the operator at a location safely spaced away from the end of the shaft in the axial direction.

In addition, the pressure screw 30 has an enlarged flange 40 on its outside end. The combination of the screw 30 and the flange 40 limits the travel of the screw and piston 32 into the chamber 33 and thus prevents potential overpressure or binding or jamming in the chamber 33.

Further, mounted on the outer hub 25 is a stop plate 45. The stop plate 45 has a hole 47 for permitting insertion of a tool for actuating the pressure screw 30. The stop plate 45 also prevents the pressure screw 30 from being unscrewed too far from the chamber 32 and potentially lost.

In combination, the flange 40 and the stop plate 45 limit the travel of the screw 30 both into and out of the chamber 33. With these limits being automatically provided, the operator is able to move the screw 30 either into or out of the chamber 33 with a minimum of thought and judgment being required, and therefore rapidly and conveniently.

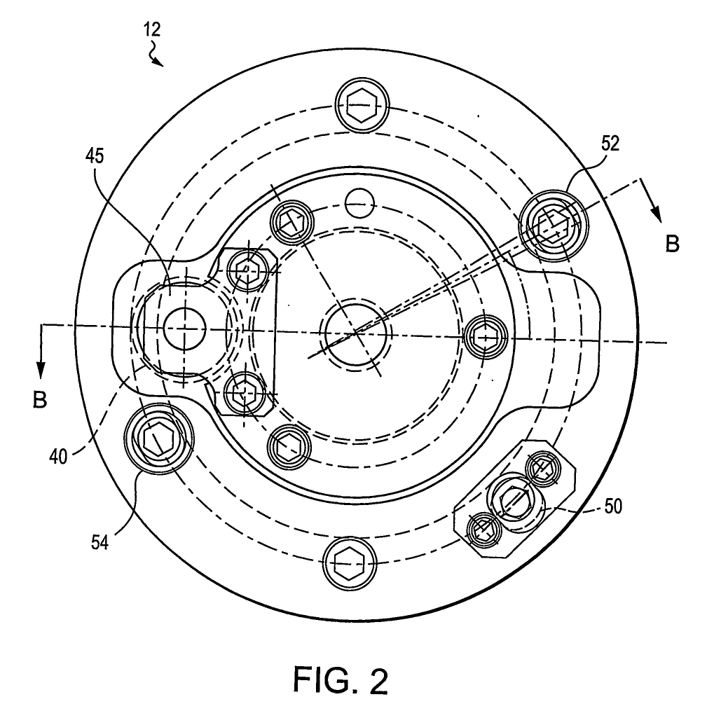

Referring now to FIG. 2, the front face of the hydraulic clamp 12 is shown. Adjustment members for fine image registration are mounted on the front face. A screw 52 allows for lateral inward adjustment. A screw 54 provides lateral outward adjustment. An eccentric stud 50 provides for radial registration.

Although the present invention has been described in relation to particular embodiments thereof, many other variations and modifications and other uses will become apparent to those skilled in the art. Therefore, the present invention is not limited by the specific disclosure herein.

1. A hydraulic clamp for being mounted on a shaft, said clamp comprising:
a hydraulic hub;
an aperture in said hydraulic hub for receiving said shaft, said aperture extending in an axial direction of said hydraulic hub from a first end to a second end thereof;
a recess formed in said hydraulic hub and substantially surrounding said aperture, for receiving a pressure medium;
said hydraulic hub having at said first end thereof a single pressure screw communicating with said recess for pressurizing said pressure medium and thereby deforming said recess sufficiently to secure said hydraulic hub to said shaft;
said single pressure screw having a corresponding single piston arranged for axial movement toward said second end for pressurizing said pressure medium.

2. The hydraulic clamp of claim 1, wherein said screw is threaded such that rotation of said screw drives said piston into a hydraulic recess toward said second end to pressurize said pressure medium.

3. The hydraulic clamp of claim 1, wherein said screw further comprises a flange, which is disposed on said screw for engaging said hydraulic hub and thereby limiting axial movement of said piston toward said second end.

4. The hydraulic clamp of claim 3, wherein said hydraulic hub further comprises a stop, which is disposed for engaging said screw and thereby limiting axial movement of said piston away from said second end.

5. The hydraulic clamp of claim 1, wherein said hydraulic hub further comprises a stop, which is disposed for engaging said screw and thereby limiting axial movement of said piston away from said second end.

6. The hydraulic clamp of claim 5, wherein said stop has a hole arranged axially of said screw, said hole permitting a tool to access said screw by being inserted generally in said axial direction.

7. In combination, the hydraulic clamp of claim 1, and a shaft received in said aperture in said hydraulic hub.

8. (canceled)

9. (canceled)

10. (canceled)

11. A hydraulic clamp for being mounted on a shaft, said clamp comprising:
a hydraulic hub;
an aperture formed in said hydraulic hub for receiving said shaft, said aperture extending in an axial direction of said hydraulic hub from a first end to a second end thereof;
a recess formed in said hydraulic hub and substantially surrounding said aperture, for receiving a pressure medium;
said hydraulic hub having a hydraulic chamber in pressure communication with said recess and a piston in said chamber movable toward said second end for pressurizing said pressure medium and thereby deforming said recess to secure said hydraulic hub to said shaft; and
a screw having a flange, which is disposed on said screw for engaging said hydraulic hub and thereby limiting axial movement of said piston toward said second end.

12. A hydraulic clamp for being mounted on a shaft, said clamp comprising:
a hydraulic hub;
an aperture formed in said hydraulic hub for receiving said shaft, said aperture extending in an axial direction of said hydraulic hub from a first end to a second end thereof;
a recess formed in said hydraulic hub and substantially surrounding said aperture, for receiving a pressure medium;
said hydraulic hub having a hydraulic chamber in pressure communication with said recess and a piston in said chamber movable toward said second end for pressurizing said pressure medium and thereby deforming said recess to secure said hydraulic hub to said shaft; and
wherein said hydraulic hub further comprises a stop, which is disposed on said hydraulic hub for engaging a screw and thereby limiting axial movement of said piston away from said second end.

13. The hydraulic clamp of claim 12, wherein said stop has a hole arranged axially of said screw, for permitting a tool to access said screw by being inserted generally in said axial direction.

14. (canceled)

15. (canceled)

16. (canceled)

17. The hydraulic clamp of claim 11, wherein said screw is threaded such that rotation of said screw drives said piston into said hydraulic chamber toward said second end to pressurize said pressure medium.

18. The hydraulic clamp of claim 12, wherein said screw is threaded such that rotation of said screw drives said piston into said hydraulic chamber toward said second end to pressurize said pressure medium.

19. The hydraulic clamp of claim 12, wherein said screw further comprises a flange, which is disposed on said screw for engaging said hydraulic hub and thereby limiting axial movement of said piston toward said second end.

20. The hydraulic clamp of claim 11, wherein said hydraulic hub further comprises a stop, which is disposed for engaging said screw and thereby limiting axial movement of said piston away from said second end.

21. The hydraulic clamp of claim 20, wherein said stop has a hole arranged axially of said screw, said hole permitting a tool to access said screw by being inserted generally in said axial direction.

22. In combination, the hydraulic clamp of claim 11, and a shaft received in said aperture in said hydraulic hub.

23. In combination, the hydraulic clamp of claim 12, and a shaft received in said aperture in said hydraulic hub.
